(19) United States
(12) Patent Application Publication
(10) Pub. No.: US 2005/0099266 A1
(43) Pub. Date: May 12, 2005

(54) Motion detection for personal identification (biometric identification and detection-anti-terrorist)

(75) Inventors: Andrew J. Parker, Novato, CA (US); Patricia I. Brenner, Encino, CA (US)

Correspondence Address: FLIESLER MEYER, LLP, FOUR EMBARCADERO CENTER, SUITE 400, SAN FRANCISCO, CA, 94111, US

(73) Assignee: Sharper Image Corporation, San Francisco, CA (US)

(21) Appl. No.: 10/932,764

(22) Filed: Sep. 2, 2004

Related U.S. Application Data
(60) Provisional application No. 60/518,755, filed on Nov. 10, 2003.

(51) Int. Cl. G06K 19/00

(52) U.S. Cl. 340/5.83; 382/124; 356/3.14

(57) ABSTRACT

A motion detection system for personalized identification is described. A sensor including a two dimensional array of pixel sensors is used to get an indication of a person's bodily features. These bodily features can be compared with a stored database in order to determine whether the person is a criminal or terrorist suspect.

### CLAIM OF PRIORITY

This application claims priority to U.S. Provisional Application 60/518,755 filed Nov. 10, 2003.

### FIELD OF THE INVENTION

The present invention relates to personal identification systems.

### BACKGROUND

Personal identification systems are systems used to identify people. An example of a personal identification system is an optical system which uses a video signal to determine the identity of a person within the picture. An example of such an optical system is a video based system that determines the key features of a persons face and then compares the key features to a database storing key features for a number of suspects. Using such a comparison, a determination whether a person is a suspect can be done. Another embodiment uses gait identification. It has been found that each person has their own identifiable way of walking or gait. Information related to gait can be stored into a database. The gait of a person in a video can be compared to this stored gait information.

It's desired to have an improved personal identification system.

### SUMMARY

One embodiment of the present invention includes an infrared sensor. The sensor includes an infrared light source to produce pulses of infrared light and optics to focus reflections from the infrared light pulse from different portions of the environment to different detectors in a 2D array of detectors. The detectors produce indications of the distances to the closest object in an associated portion of the environment. A processor uses the indications from the infrared sensor to identify a person.

### BRIEF DESCRIPTION OF THE DRAWINGS

FIG. 1 is a diagram that illustrates a personal identification system of one embodiment of the present invention.

FIG. 2 is a diagram that illustrates a cross-sectional view of the operation of an infrared sensor used in a personal identification system of one embodiment of the present invention.

FIG. 3 is a diagram that illustrates an examples of reflected pulses used with example of FIG. 2.

### DETAILED DESCRIPTION

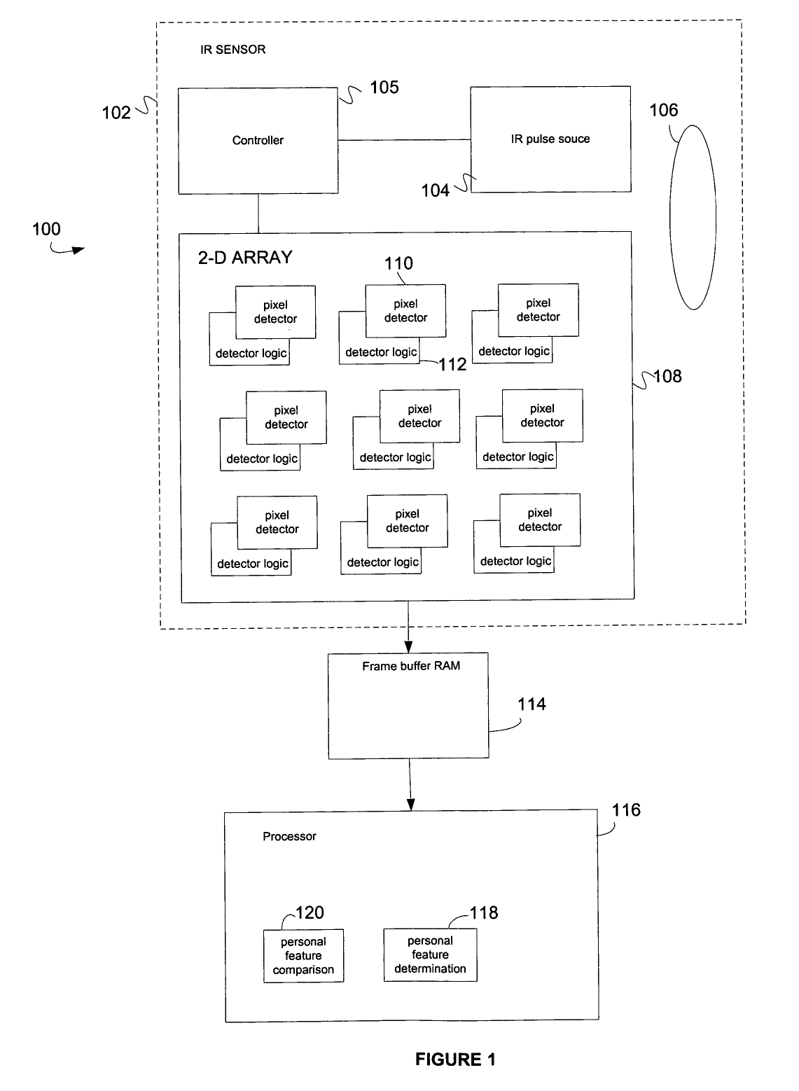

One embodiment of the present invention is personal identification device, such as the personal identification device 100 shown in FIG. 1. The personal identification device can be a computer based system.

An infrared sensor 102 includes an infrared light source 104. The infrared light source 104 can produce pulses of infrared light. The infrared light sensor 102 includes optics 106 to focus reflections from an infrared light source pulse from different portions of the environment to different detectors in a two dimensional (2D) array of the detectors 108. The optics 106 can include a single or multiple optical elements. In one embodiment, the optics 106 focus light reflected from different regions of the environment to the detectors in the 2D array 108.

The detectors produce indications of the distances to the closest objects in associated portions of the environment. For the personal identification, devices these objects can be body parts. In the example of FIG. 1, the 2D array includes pixel detectors 110 and associated detector logic 112. In one embodiment, the 2D array of detectors is constructed of CMOS technology on a semiconductor substrate. The pixel detectors can be photodiodes. The detector logic 112 can include counters. In one embodiment, a counter for a pixel detector runs until a reflected pulse is received. The counter value thus indicates the elapsed time for a pulse to be sent from the IR sensor and reflected back from an object in the environment to the pixel detector. Different portions of environment with different object distances will have different pulse transit times.

In one embodiment, each detector produces an indication of the distance to the closest object in the associated portion of the environment. Such indications can be sent from the 2D detector array 108 to a memory such as the Frame Buffer RAM 114 that stores frames of indications. A frame can contain distance indication data of the pixel detectors for a single pulse. Controller 105 can be used to initiate the operation of the IR pulse source 104 as well as to control the counters in the 2D detector array 108.

An exemplary infrared sensor for use in the present invention is available from Canesta, Inc. of San Jose, Calif. Details of such infrared sensors are described in the U.S. Pat. No. 6,323,932 and published patent applications U.S. 2002/0140633 A1, U.S. 2002/0063775 A1, U.S. 2003/0076484 A1 each of which are incorporated herein by reference.

The processor 116 can receive the indications from the infrared sensor 108 from the infrared sensors 102. The processor 116 can use the indications to determine the identity of a person. In one embodiment, the personal feature determination software 118 takes the identifications and identifies features of a person from the indications. An example of the personal features that can be determined include key body features such as waist position, leg positions, torso orientations, head positions and the like. These personal features, once determined, can be compared with personal features of suspects in a database. In one example, the personal feature detection database of criminal suspects or terrorist suspects can be compared with the personal features in the identified in the personal feature determination.

In one embodiment, gait determination is done. In the gait determination, some personal features are identified and the gait is determined by tracking the personal features over time as the person walks. In one embodiment, the personal feature comparison 120 compares this train of features with a stored gait indications of suspects.

In an alternate embodiment, the indications can be used for a face identification. In a face identification system, the persons face is put in front of the sensor. The indications produced by the sensor of the persons face gives three dimensional depth indications of the persons face. These indications can be stored for identifying the person. Systems of the present invention can be used alone or can be used in combination with other personal identification units including photographs, videos and the like.

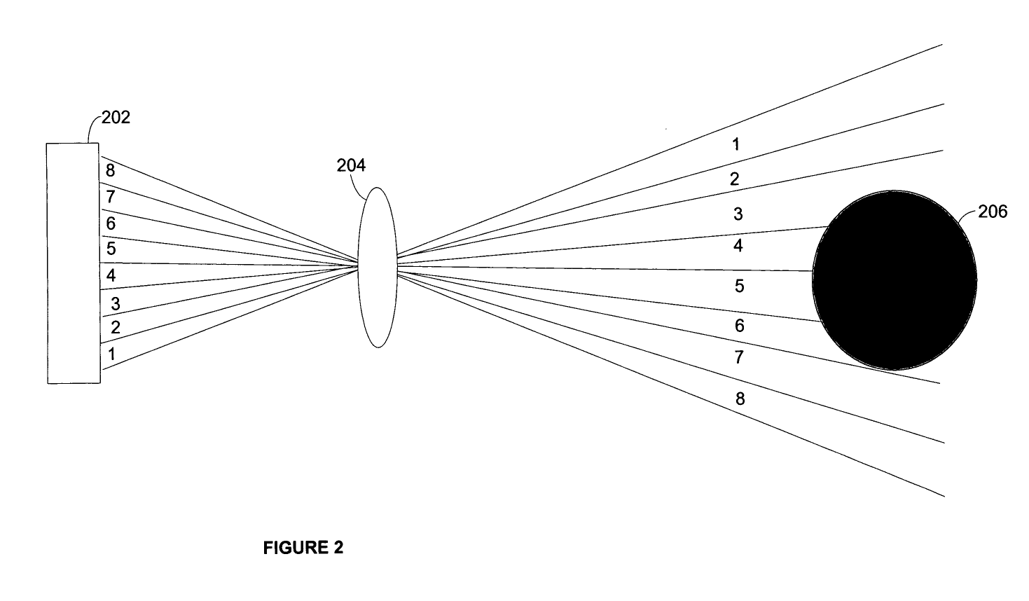

FIG. 2 illustrates the operation of a cross-section of the 2D detector array. In the example of FIG. 2, the 2D array detectors 206 and optics 204 are used to determine the location of a person 206 within the environment. FIG. 2 shows definition of a users waist. In this example, reflections are received from regions 3, 4, 5 and 6. The time to receive these reflections can be used to determine the position of the closest object within the region of the environment.

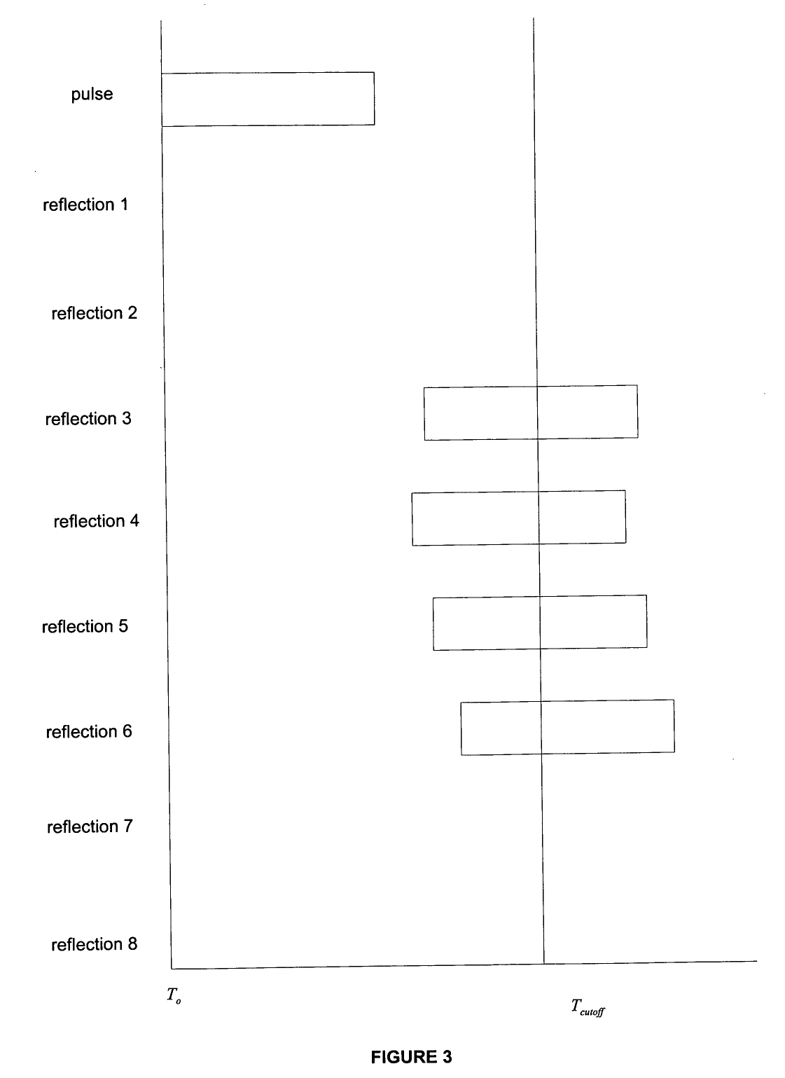

In the example of FIG. 3, a pulse is created and is sent to each of the regions 1 to 8 shown in FIG. 2. Regions 1, 2, 7 and 8 do not reflect the pulses to the sensor; regions 3, 4, 5 and 6 do reflect the pulses to the sensor. The time to receive the reflected pulse indicates the distance to object(s).

In one embodiment, the system measures the reflected pulse duration or energy up to a cutoff time, t_{cutoff}. This embodiment can reduce the detected noise in some situations.

In one embodiment, the input device examines the position of the users arm, hand or other object placed within a operating region of the infrared sensor. The distance indications from the 2D detector give a two-dimensional mapping of the closest object within the different portions of the environment.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A personal identification system comprising:
an infrared sensor, the sensor including an infrared light source to produce pulses of infrared light, optics to focus reflections from the infrared light pulses from different portions of the environment to different detectors in a 2D array of detectors, the detectors producing indications of distances to the closest object in an associated portion of the environment; and
a processor using the indications from the infrared sensor to identify a person.

2. The personal identification system of claim 1, wherein the personal identification uses gait identification.

3. The personal identification system of claim 1, wherein the personal identification determines bodily features.

4. The personal identification system of claim 3, wherein the bodily features are tracked over time.

5. The personal identification system of claim 1, wherein a warning is produced if the person identified is a criminal or terrorist suspect.

6. A method comprising:
producing pulses of infrared light;
focusing reflections of the infrared light pulse from different portions of the environment to different detectors in a 2D array of detectors;
at the detectors, producing indications of the distances to the closest object in associated portions of the environment; and
using the indications to identify a person.

7. The method of claim 6, wherein the personal identification uses gait identification.

8. The method of claim 6, wherein the personal identification determines bodily features.

9. The method of claim 8, wherein the bodily features are tracked over time.

10. The method of claim 6, wherein a warning is produced if the person identified is a criminal or terrorist suspect.
